(19) United States
(12) Patent Application Publication
(10) Pub. No.: US 2019/0019414 A1
(43) Pub. Date: Jan. 17, 2019

(54) APPARATUS AND METHOD FOR REMINDING VEHICLE LANE CHANGE AND VEHICLE

(71) Applicant: BOE Technology Group Co., Ltd., Beijing (CN)

(72) Inventor: Hongtao GUAN, Beijing (CN)

(21) Appl. No.: 15/941,031

(22) Filed: Mar. 30, 2018

(30) Foreign Application Priority Data
Jul. 13, 2017 (CN) 201710569031.2

(51) Int. Cl. G08G 1/16; B60Q 9/00; H04N 7/18; G06K 9/32; G06K 9/00

(52) U.S. Cl. CPC G08G 1/167; B60Q 9/00; G06K 9/00791; G06K 9/3258; H04N 7/181

(57) ABSTRACT

This disclosure provides an apparatus and method for reminding a vehicle lane change and a vehicle. The apparatus for reminding a vehicle lane change comprises: an image capturing member configured to capture an identification code image of a target vehicle; an image processing member configured to determine an identification code of the target vehicle based on the identification code image; an input member configured to receive lane change direction information input by a user; and a first communication member configured to send lane change information including the identification code of the target vehicle and the lane change direction information.

### CROSS-REFERENCE TO RELATED APPLICATION

This application claims the priority of Chinese Patent Application No. 201710569031.2 submitted to the Chinese Intellectual Property Office on Jul. 13, 2017, the disclosure of which is incorporated herein in its entirety by reference.

### TECHNICAL FIELD

This disclosure relates to the technical field of automobile safety driving, and particularly relates to an apparatus and method for reminding a vehicle lane change and a vehicle.

### BACKGROUND OF THE INVENTION

When driving on a highway, in order to avoid traffic accidents during vehicle lane changes, some drivers who want to change lanes will warn nearby drivers by whistle. However, due to weather and other reasons (such as rain and snow, cold weather, etc.), the windows are usually closed on the highway. Thus, when a rear vehicle reminds a front vehicle of lane change by whistle, it is often difficult for the front driver to hear the whistle of the rear vehicle, which leads to an unsatisfactory reminding effect.

Therefore, there is an urgent need for a vehicle lane change reminding solution to solve the above technical problem.

### SUMMARY

According to one aspect of the disclosure, there is provided an apparatus for reminding a vehicle lane change comprising:

an image capturing member configured to capture an identification code image of a target vehicle;

an image processing member configured to determine an identification code of the target vehicle based on the identification code image;

an input member configured to receive lane change direction information input by a user; and

a first communication member configured to send lane change information including the identification code of the target vehicle and the lane change direction information.

In one embodiment, the first communication member may be further configured to receive the lane change information sent by other vehicles, and the apparatus for reminding a vehicle lane change may further comprise:

a reminding member configured to send a lane change reminder; and

a control member configured to encode the identification code of the target vehicle in the lane change information sent by other vehicles to generate identification code information of the target vehicle, and determine whether to control the reminding member to start based on the identification code information of the target vehicle and preset identification code information of the present vehicle.

In another embodiment, the control member may be configured to compare the identification code information of the target vehicle with the preset identification code information of the present vehicle, and control the reminding member to start when the identification code information of the target vehicle is the same as the preset identification code information of the present vehicle.

In another embodiment, the reminding member may be configured to broadcast by voice the lane change direction information in the lane change information sent by other vehicles.

In another embodiment, the apparatus for reminding a vehicle lane change may further comprise:

a ranging member configured to detect a distance between the present vehicle and the target vehicle,

the control member is further configured to compare the distance with a preset threshold, and control the image capturing member to start when the distance is smaller than or equal to the threshold.

In another embodiment, the ranging member may be located in at least one of just front, left front and right front of a vehicle head of the vehicle, and is configured to detect a distance between the present vehicle and a front vehicle located corresponding to a location of the ranging member.

In another embodiment, the number of the image capturing member is one, and the image capturing member may be a wide-angle camera device.

In another embodiment, the image capturing member may include a first image capturing member, a second image capturing member and a third image capturing member, the first image capturing member is located in just front of the vehicle head and configured to capture an identification code image of a just front vehicle, the second image capturing member is located in left front of the vehicle head and configured to capture an identification code image of a left front vehicle, and the third image capturing member is located in right front of the vehicle head and configured to capture an identification code image of a right front vehicle.

In another embodiment, the apparatus for reminding a vehicle lane change may further comprise:

a second communication member configured to receive an identification code of the present vehicle sent by a user and send the identification code of the present vehicle to the control member,

the control member is further configured to encode the identification code of the present vehicle to generate the identification code information of the present vehicle.

In another embodiment, the lane change direction may include left lane change and right lane change, and the input member includes a left lane change button and a right lane change button.

According to another aspect of the disclosure, there is provided a vehicle including the above apparatus for reminding a vehicle lane change.

According to still another aspect of the disclosure, there is provided a method for reminding a vehicle lane change comprising:

capturing an identification code image of a target vehicle;

determining an identification code of the target vehicle based on the identification code image;

receiving lane change direction information input by a user; and

sending lane change information including the identification code of the target vehicle and the lane change direction information.

In another embodiment, the method may further include:

receiving the lane change information sent by other vehicles;

encoding the identification code of the target vehicle in the lane change information sent by other vehicles to generate identification code information of the target vehicle; and

determining whether to send a lane change reminder based on the identification code information of the target vehicle and preset identification code information of the present vehicle.

In another embodiment, determining whether to send the lane change reminder based on the identification code information of the target vehicle and the preset identification code information of the present vehicle may comprise:

comparing the identification code information of the target vehicle with the preset identification code information of the present vehicle, and sending the lane change reminder when the identification code information of the target vehicle is the same as the preset identification code information of the present vehicle.

In another embodiment, sending the reminder may further include:

broadcasting by voice the lane change direction information in the lane change information sent by other vehicles.

In another embodiment, before capturing the identification code image of the target vehicle, the method may further comprise:

detecting a distance between the present vehicle and the target vehicle; capturing the identification code image of the target vehicle comprises:

comparing the distance with a preset threshold, and capturing the identification code image of the target vehicle when the distance is smaller than or equal to the threshold.

### BRIEF DESCRIPTION OF THE FIGURES

FIG. 1 is a schematic diagram showing a configuration of the apparatus for reminding a vehicle lane change according to an exemplary embodiment of the disclosure; and

FIG. 2 is a flow chart showing the method for reminding a vehicle lane change according to an exemplary embodiment of the disclosure.

### DETAILED DESCRIPTION

Hereinafter, an exemplary embodiment of the present disclosure will be clearly and completely described with reference to the accompanying drawings. Apparently, the described exemplary embodiments are only some but not all of the embodiments of the present disclosure. All other embodiments obtained by those of ordinary skill in the art based on an exemplary embodiment of the present disclosure without making any creative effort shall fall within the protection scope of the present disclosure.

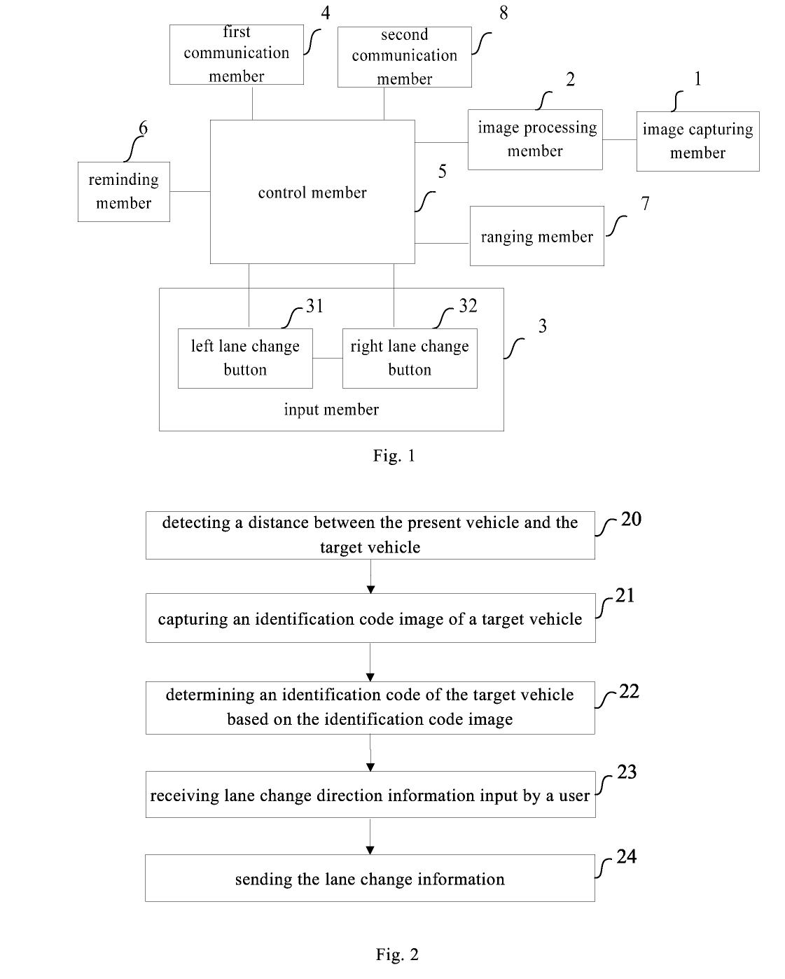

According to one aspect of the disclosure, there is provided an apparatus for reminding a vehicle lane change. As shown in FIG. 1, the apparatus for reminding a vehicle lane change includes an image capturing member 1, an image processing member 2, an input member 3 and a first communication member 4. The image capturing member 1 is configured to capture an identification code image of a target vehicle, the identification code of the vehicle may be anything identifying the vehicle, for example, a specific pattern, number, character string and so on. The specific form of that is not limited herein. In an exemplary embodiment of the disclosure, the identification code of the vehicle is a license plate number of the vehicle, and the identification code image of the target vehicle is a license plate of the target vehicle. The image processing member 2 is configured to determine an identification code of the target vehicle based on the identification code image. The input member 3 is configured to receive lane change direction information input by a user. The first communication member 4 is configured to send lane change information including the identification code of the target vehicle and the lane change direction information.

The principle of the apparatus for reminding a vehicle lane change according to an exemplary embodiment of the disclosure lies in that: by capturing an identification code image of a front vehicle, a rear vehicle sends lane change information including identification code of the front vehicle and lane change direction information of the rear vehicle before changing a lane to inform nearby vehicles of the intended lane change direction of the rear vehicle. By this way, the front vehicle is informed of the intention of changing lanes of the rear vehicle. Thus, the driver of the front vehicle is reminded timely to note the lane change action of the rear vehicle even if the windows are closed, thereby avoiding traffic accidents and guaranteeing driving safety.

In an exemplary embodiment of the disclosure, the target vehicle is a vehicle in just front, left front or right front of the present vehicle.

In an exemplary embodiment of the disclosure, the image capturing member 1 may be a camera device, and the number of image capturing memberl may be one or more. For example, the image capturing member 1 may include three parts: a first image capturing member, a second image capturing member and a third image capturing member. The first image capturing member is located in just front of the vehicle head and configured to capture an identification code image of a just front vehicle; the second image capturing member is located in left front of the vehicle head and configured to capture an identification code image of a left front vehicle; and the third image capturing member is located in right front of the vehicle head and configured to capture an identification code image of a right front vehicle. That is, the image capturing member 1 captures identification code images of vehicles in just front, left front and right front through three different image capturing members. Thus, the first, second and third image capturing members can be selected to be ordinary cameras. By disposing cameras in different directions, identification code images of target vehicles in different locations can be captured, thereby ensuring safe lane changes in different directions.

When there is only one image capturing member 1, the image capturing member 1 may be a wide-angle camera to expand the angle of view. In this way, the capturing of identification code images of vehicles in just front, left front and right front can be completed by one wide-angle camera, which saves spaces and improves convenience.

In an exemplary embodiment of the disclosure, the image capturing member 1 may be a camera such as a CCD camera or CMOS camera. However, the image capturing member 1 of the disclosure is not limited thereto, but may also be any other device capable of capturing an image.

Since the vehicle identification code image captured by the image capturing member 1 cannot be directly recognized, the image processing member 2 is desired to extract the vehicle identification code from the image and convert it into a digital or text format so as to send it in the digital or text format later. The identification code may be extracted from the identification code image by image processing algorithms such as image segmentation or edge extraction. Specifically, the image processing member 2 performs black and white processing on the vehicle identification code image, recognizes characteristics of the identification code, and uses the neural network learning function of the pattern recognition algorithm to determine the identification code of the target vehicle in the digital or text format.

In an exemplary embodiment of the disclosure, the image processing member 2 may be implemented as an IC chip such as a graphics processor or video processor. However, the image processing member 2 of the disclosure is not limited thereto, but may also be any other device capable of processing an image.

The lane change direction includes left lane change and right lane change. Accordingly, the input member 3 includes a left lane change button and a right lane change button. When the driver of the rear vehicle (i.e., the user) intends to change the lane from left, the left lane change button may be pushed; and when the driver of the rear vehicle intends to change the lane from right, the right lane change button may be pushed. However, the left and right lane change buttons are not limited to physical buttons, but may also be, for example, voice control that recognizes voice commands of changing the lane from left or right by the driver. By means of the left and right lane change buttons, operations of corresponding lane changes by the driver are facilitated.

In an exemplary embodiment of the disclosure, the input member 3 may also be implemented as a mechanical button or an input interface of a display screen. However, the input member 3 of the disclosure is not limited thereto, but may also be any other device or input circuit capable of being input by a user.

In an exemplary embodiment of the disclosure, the first communication member 4 may be an RF circuit, such as a 433M RF circuit. By the RF circuit, the lane change information of the rear vehicle may be broadcast, and other vehicles nearby the rear vehicle may receive the lane change information by a corresponding first communication member 4, thereby realizing transmission of the lane change information of the rear vehicle.

In an exemplary embodiment of the disclosure, the first communication member 4 may also be implemented as a DSP chip or embedded chip. However, the first communication member 4 of the disclosure is not limited thereto, but may also be any other device or communication circuit capable of information exchanges.

In an exemplary embodiment of the disclosure, the lane change information may further include identification code information of the present vehicle so that the front vehicle can know which rear vehicle is to change the lane.

In an exemplary embodiment of the disclosure, as shown in FIG. 1, the apparatus for reminding a vehicle lane change may further include a control member 5 and a reminding member 6. The reminding member 6 is configured to send a lane change reminder. The first communication member 4 is further configured to receive the lane change information sent by other vehicles. The control member 5 is configured to encode the identification code of the target vehicle in the lane change information sent by other vehicles to generate identification code information of the target vehicle, and determine whether to control the reminding member to start based on the identification code information of the target vehicle and preset identification code information of the present vehicle.

In an exemplary embodiment of the disclosure, the control member 5 is specifically configured to compare the identification code information of the target vehicle with the preset identification code information of the present vehicle, and control the reminding member 6 to start when the identification code information of the target vehicle is the same as the preset identification code information of the present vehicle.

It should be noted that the identification code information of the present vehicle is stored in a Flash (flash memory) in the form of a hexadecimal address code, while the control member 5, after receiving the lane change information sent by the first communication member 4, obtains the identification code of the target vehicle from the lane change information, converts the identification code of the target vehicle into a hexadecimal address code, i.e., the identification code information of the target vehicle, according to an encoding protocol, and compares the identification code information of the target vehicle with the identification code information of the present vehicle invoked from the Flash. When the two kinds of identification code information are the same, the reminding member 6 is controlled to start. In an exemplary embodiment of the disclosure, the identification code information of the present vehicle and the identification code information of the target vehicle are both converted according to an identification code encoding protocol. Obviously, those skilled in the art will understand that the identification code information of the present vehicle and the identification code information of the target vehicle may be directly compared without the above conversion.

In an exemplary embodiment of the disclosure, the control member 5 may be a Microcontroller Unit (MCU).

The apparatus for reminding a vehicle lane change of the disclosure generates identification code information of the target vehicle based on the identification code in the lane change information, and determines whether to control the reminding member 6 to start, i.e., whether to send the lane change reminder, based on the identification code information of the target vehicle and the identification code information of the present vehicle pre-stored in the control member 5 of the present vehicle. When a rear vehicle intends to change the lane, the apparatus for reminding a vehicle lane change of the disclosure may inform and remind a front vehicle of the lane change action of the rear vehicle timely.

In an exemplary embodiment of the disclosure, the reminding member 6 is specifically configured to broadcast by voice the lane change direction information in the lane change information sent by other vehicles.

It should be noted that the reminding member 6 may be further configured as a display device for displaying the lane change information sent by other vehicles so that the driver can determine autonomously whether it is necessary to avoid or raise vigilance.

The reminding member 6 may include two reminding modes for the driver to select according to actual situations. One is broadcasting by voice the lane change direction information, and the other is displaying the lane change direction information on a display.

It should be noted that when the lane change information further includes an identification code of the rear vehicle, the reminding member 6 of the front vehicle may also broadcast by voice or display the identification code of the rear vehicle, for example, broadcasting by voice or displaying the following information: “vehicle with the license plate number xxxxxxxx is about to change lane from the left, please pay attention to traffic safety”.

In an exemplary embodiment of the disclosure, as shown in FIG. 1, the apparatus for reminding a vehicle lane change may further include a ranging member 7 which is configured to detect a distance between the present vehicle and the target vehicle. The control member 5 is further configured to compare the distance detected by the ranging member 7 with a preset threshold, and control the image capturing member 1 to start when the distance is smaller than or equal to the threshold.

If the rear vehicle is far away from the front vehicle, the front vehicle will hardly be affected even if the rear vehicle changes lanes. Therefore, by detecting the distance between the present vehicle and the front vehicle with the ranging member 7, the disclosure starts the image capturing member 1 to capture the identification code image of the front vehicle only when the distance between the present vehicle and the front vehicle is relatively smaller, thereby not only improving effectiveness of the lane change reminding, but also relieving the processing work of the image processing member 2.

In an exemplary embodiment of the disclosure, the threshold is about 50˜100 m.

In an exemplary embodiment of the disclosure, the ranging member 7 is an ultrasonic range finder or any other device capable of ranging.

In an exemplary embodiment of the disclosure, the ranging member 7 is located in just front, left front and/or right front of a vehicle head of the vehicle, and is configured to detect a distance between the present vehicle and a front vehicle located corresponding to a location of the ranging member 7. That is, a ranging member 7 in just front of the vehicle head detects a distance between the present vehicle and a just front vehicle, a ranging member 7 in left front of the vehicle head detects a distance between the present vehicle and a left front vehicle, and a ranging member 7 in right front of the vehicle head detects a distance between the present vehicle and a right front vehicle. By providing ranging members 7 at different locations, the starting time of the image capturing member 1 may be controlled more precisely.

In an exemplary embodiment of the disclosure, as shown in FIG. 1, the apparatus for reminding a vehicle lane change further includes a second communication member 8 which is configured to receive an identification code of the present vehicle sent by the user and send the identification code of the present vehicle to the control member 5. The control member 5 is further configured to encode the identification code of the present vehicle to generate the identification code information of the present vehicle.

In an exemplary embodiment of the disclosure, the control member 5 converts the identification code of the present vehicle into a hexadecimal address code (i.e., identification code information of the present vehicle) according to an encoding protocol, and stores the hexadecimal address code in a Flash of a vehicle terminal.

In an exemplary embodiment of the disclosure, the second communication member 8 may also be a Bluetooth device or be implemented as a DSP chip or embedded chip. However, the second communication member 8 of the disclosure is not limited thereto, but may also be any other device or communication circuit capable of information exchanges.

The identification code of the present vehicle is stored in the vehicle terminal when the apparatus for reminding a vehicle lane change is firstly mounted on a vehicle. The user may connect to the apparatus for reminding a vehicle lane change through Bluetooth with an APP (Application) on mobile phones, and input the license plate number of the present vehicle through the APP. The license plate number of the present vehicle is transmitted to the control member 5 by means of the Bluetooth device of the mobile phone and the second communication member 8 of the apparatus for reminding a vehicle lane change. After receiving the license plate number of the present vehicle, the control member 5 generates a corresponding hexadecimal address code according to an encoding protocol, and stores it in the Flash.

According to another aspect of the disclosure, there is provided a vehicle including the above apparatus for reminding a vehicle lane change, the vehicle may be an automobile.

According to still another aspect of the disclosure, there is provided a method for reminding a vehicle lane change applied in the apparatus for reminding a vehicle lane change. As shown in FIG. 2, the method includes the steps of:

Step 21, capturing an identification code image of a target vehicle.

Specifically, the image capturing member 1 captures the identification code image of the target vehicle. The target vehicle is a vehicle in just front, left front or right front of the present vehicle. The identification code of the vehicle is the license plate number of the vehicle.

Step 22, determining an identification code of the target vehicle based on the identification code image.

Specifically, the image processing member 2 performs black and white processing on the vehicle identification code image, recognizes characteristics of the identification code, and uses the neural network learning function of the pattern recognition algorithm to determine the identification code of the target vehicle in the digital or text format.

Step 23, receiving lane change direction information input by a user.

Specifically, the driver of the present vehicle input the lane change direction information to the apparatus for reminding a vehicle lane change through a left lane change button or a right lane change button.

Step 24, sending the lane change information.

Specifically, the first communication member 4 sends by RF the lane change information including the identification code of the target vehicle and the lane change direction information.

It can be seen from Steps 21 to 24 that by capturing an identification code image of a front vehicle, a rear vehicle sends lane change information including identification code of the front vehicle and lane change direction information before changing a lane to inform nearby vehicles of the intended lane change direction of the rear vehicle. By this way, the front vehicle is informed of the intention of changing lanes of the rear vehicle. Thus, the driver of the front vehicle is reminded timely to note the lane change action of the rear vehicle even if the windows are closed, thereby avoiding traffic accidents and guaranteeing driving safety.

In an exemplary embodiment of the disclosure, before the Step 21, the method may further include the step of:

Step 20, detecting a distance between the present vehicle and the target vehicle.

Specifically, the ranging member 7 may be located in just front, left front and/or right front of a vehicle head of the vehicle, and is configured to detect a distance between the present vehicle and a front vehicle located corresponding to a location of the ranging member 7.

Accordingly, the control member 5 compares the distance detected by the ranging member 7 with a preset threshold. If the distance is smaller than or equal to the threshold, move to the Step 21, i.e., capturing the identification code image of the target vehicle.

By detecting the distance between the present vehicle and the front vehicle with the ranging member 7, the disclosure starts the image capturing member 1 to capture the identification code image of the front vehicle only when the distance between the present vehicle and the front vehicle is relatively smaller, thereby not only improving effectiveness of the lane change reminding, but also relieving the processing work of the image processing member 2.

In an exemplary embodiment of the disclosure, the method for reminding a vehicle lane change further includes the step of:

receiving the lane change information sent by other vehicles and encoding the identification code of the target vehicle in the lane change information to generate identification code information of the target vehicle, and determining whether to send the lane change reminder based on the identification code information of the target vehicle and preset identification code information of the present vehicle.

It should be noted that this step may be performed simultaneously with Steps 21 to 24.

Specifically, the control member 5 compares the identification code information of the target vehicle with the preset identification code information of the present vehicle, and controls the reminding member 6 to start when the identification code information of the target vehicle is the same as the preset identification code information of the present vehicle. When the identification code information of the target vehicle is different from the identification code information of the present vehicle, a current state is maintained (i.e., the reminding member 6 is not started).

Specifically, sending the lane change reminder includes: with the reminding member 6, broadcasting by voice the lane change direction information in the lane change information sent by other vehicles.

It can be seen from this step that whether to send the lane change reminder is determined based on the identification code information of the target vehicle corresponding to the identification code in the lane change information and the identification code information of the present vehicle stored in the control member 5 of the present vehicle. When a rear vehicle intends to change the lane, the method for reminding a vehicle lane change of the disclosure may inform and remind a front vehicle of the lane change action of the rear vehicle timely.

It should be noted that in an initialization phase of the device, the method further includes the step of: receiving and encoding the identification code of the present vehicle sent by the user to generate and store identification code information of the present vehicle.

Specifically, the second communication member 8 receives the identification code of the present vehicle sent by the user and sends the identification code of the present vehicle to the control member 5. The control member 5 generates a hexadecimal address code, i.e., identification code information of the present vehicle, based on the identification code of the present vehicle, and stores the identification code information of the present vehicle in a Flash for later invoking.

It should be understood that the above embodiments are merely exemplary embodiments for the purpose of illustrating the principle of the disclosure, and the disclosure is not limited thereto. Various modifications and improvements can be made by a person having ordinary skill in the art without departing from the spirit and essence of the disclosure. Accordingly, all of the modifications and improvements also fall into the protection scope of the disclosure.

What is claimed is:

1. An apparatus for reminding a vehicle lane change comprising:
an image capturing member configured to capture an identification code image of a target vehicle;
an image processing member configured to determine an identification code of the target vehicle based on the identification code image;
an input member configured to receive lane change direction information input by a user; and
a first communication member configured to send lane change information including the identification code of the target vehicle and the lane change direction information.

2. The apparatus for reminding a vehicle lane change according to claim 1,
wherein the first communication member is further configured to receive the lane change information sent by other vehicles, and the apparatus for reminding a vehicle lane change further comprises:
a reminding member configured to send a lane change reminder; and
a control member configured to encode the identification code of the target vehicle in the lane change information sent by other vehicles to generate identification code information of the target vehicle, and determine whether to control the reminding member to start based on the identification code information of the target vehicle and preset identification code information of the present vehicle.

3. The apparatus for reminding a vehicle lane change according to claim 2,
wherein the control member is configured to compare the identification code information of the target vehicle with the preset identification code information of the present vehicle, and control the reminding member to start when the identification code information of the target vehicle is the same as the preset identification code information of the present vehicle.

4. The apparatus for reminding a vehicle lane change according to claim 2,
wherein the reminding member is configured to broadcast by voice the lane change direction information in the lane change information sent by other vehicles.

5. The apparatus for reminding a vehicle lane change according to claim 1 further comprising:
a ranging member configured to detect a distance between the present vehicle and the target vehicle,
wherein the control member is further configured to compare the distance with a preset threshold, and control the image capturing member to start when the distance is smaller than or equal to the threshold.

6. The apparatus for reminding a vehicle lane change according to claim 5,
wherein the ranging member is located in at least one of just front, left front and right front of a vehicle head of the vehicle, and is configured to detect a distance between the present vehicle and a front vehicle located corresponding to a location of the ranging member.

7. The apparatus for reminding a vehicle lane change according to claim 6,
wherein the number of the image capturing member is one, and the image capturing member is a wide-angle camera device.

8. The apparatus for reminding a vehicle lane change according to claim 6,
wherein the image capturing member includes a first image capturing member, a second image capturing member and a third image capturing member; and
wherein the first image capturing member is located in just front of the vehicle head and configured to capture an identification code image of a just front vehicle, the second image capturing member is located in left front of the vehicle head and configured to capture an identification code image of a left front vehicle, and the third image capturing member is located in right front of the vehicle head and configured to capture an identification code image of a right front vehicle.

9. The apparatus for reminding a vehicle lane change according to claim 2 further comprising:
a second communication member configured to receive an identification code of the present vehicle sent by a user and send the identification code of the present vehicle to the control member,
wherein the control member is further configured to encode the identification code of the present vehicle to generate the identification code information of the present vehicle.

10. The apparatus for reminding a vehicle lane change according to claim 1,
wherein the lane change direction includes left lane change and right lane change, and the input member includes a left lane change button and a right lane change button.

11. A vehicle comprising the apparatus for reminding a vehicle lane change according to claim 1.

12. A method for reminding a vehicle lane change comprising:
capturing an identification code image of a target vehicle;
determining an identification code of the target vehicle based on the identification code image;
receiving lane change direction information input by a user; and
sending lane change information including the identification code of the target vehicle and the lane change direction information.

13. The method according to claim 12 further comprising:
receiving the lane change information sent by other vehicles;
encoding the identification code of the target vehicle in the lane change information sent by other vehicles to generate identification code information of the target vehicle; and
determining whether to send a lane change reminder based on the identification code information of the target vehicle and preset identification code information of the present vehicle.

14. The method according to claim 13,
wherein determining whether to send a lane change reminder based on the identification code information of the target vehicle and the preset identification code information of the present vehicle comprises:
comparing the identification code information of the target vehicle with the preset identification code information of the present vehicle, and sending the lane change reminder when the identification code information of the target vehicle is the same as the preset identification code information of the present vehicle.

15. The method according to claim 14,
wherein sending the lane change reminder comprises:
broadcasting by voice the lane change direction information in the lane change information sent by other vehicles.

16. The method according to claim 11, before capturing the identification code image of the target vehicle, the method further comprising:
detecting a distance between the present vehicle and the target vehicle;
wherein capturing the identification code image of the target vehicle comprises:
comparing the distance with a preset threshold, and capturing the identification code image of the target vehicle when the distance is smaller than or equal to the threshold.
